(19) United States
(12) Patent Application Publication
(10) Pub. No.: US 2015/0028630 A1
(43) Pub. Date: Jan. 29, 2015

(54) ROOF CONSTRUCTION FOR A MOTOR VEHICLE AND MOTOR VEHICLE BODYSHELL

(71) Applicants: Rainer Grimm, Frankfurt (DE); Carmelo Mondello, Kronberg (DE)

(72) Inventors: Rainer Grimm, Frankfurt (DE); Carmelo Mondello, Kronberg (DE)

(21) Appl. No.: 14/335,342

(22) Filed: Jul. 18, 2014

(30) Foreign Application Priority Data
Jul. 29, 2013 (DE) 10 2013 108 081.2

(51) Int. Cl. B60J 7/047; B60J 10/12; B60J 7/00

(52) U.S. Cl. CPC B60J 7/047; B60J 7/0084; B60J 10/12
USPC 296/213

(57) ABSTRACT

There is provided a roof construction with a sliding roof module and at least one further roof module, wherein between the sliding roof module and the roof module a transverse strut is arranged, which is part of a vehicle body, wherein an edge portion of the sliding roof module and an edge of the roof module are connected with the transverse strut and between the two roof modules a water channel is formed.

### CROSS REFERENCE TO RELATED APPLICATIONS

This application claims priority under 35 U.S.0 §119 to the following German Patent Application No. DE 10 2013 108 081.2 filed on Jul. 29, 2013, the contents of which are incorporated herein by reference thereto.

### BACKGROUND

The invention relates to a roof construction with a sliding roof module and at least one further roof module.

In motor vehicles several roof modules frequently are mounted at the roof construction, for example the sliding roof module and the further roof module. The sliding roof module contains a lid which proceeding from a closed position can be opened partly or completely, so that fresh air flows into the vehicle interior. The further roof module can be formed stationary, for example as a large-surface pane, or also in the form of a second sliding roof module which in turn is provided with a lid.

The more functions the individual roof modules have, the more complicated does it become to mount the same at the roof construction of the vehicle. The object of the invention consists in creating a roof construction in which the sliding roof module and the further roof module can reliably be mounted with as little effort as possible. Accordingly, it is desirable to provide an improved roof construction and/or improved sliding roof module and/or improved roof module.

### SUMMARY OF THE INVENTION

For the solution of this object a roof construction with a sliding roof module and at least one further roof module is provided according to the invention, wherein between the sliding roof module and the roof module a transverse strut is arranged, which is part of a vehicle body, wherein an edge portion of the sliding roof module and an edge of the roof module are connected with the transverse strut and between the two roof modules a water channel is formed. The two roof modules can be mounted at the transverse strut separate from and independent of each other, so that they cannot only be mounted easily, but if necessary also can be demounted independent of each other. This is supported by the water channel which is formed between the two roof modules with little effort, so that water which enters between the two roof modules can be discharged reliably. The water channel creates the free space between the two roof modules, so that it is possible to work there at one of the two modules, while the other one can remain at its place.

Preferably, it is provided that the two roof modules are bonded to the transverse strut. In this way, a tight connection between the roof modules and the transverse strut can be achieved with little effort.

According to one embodiment of the invention it is provided that the further roof module is foam-clad with polyurethane (PU) at its edge associated to the transverse strut, wherein the polyurethane (PU) does not have a reinforcing element in the region of this edge. Preferably, it can be provided that the polyurethane (PU) foam cladding is bonded directly to the transverse strut. This provides for forming the polyurethane (PU) foam cladding of the further roof module, in particular when the same is designed in the form of a stationary pane, with small cross-section, without this leading to losses of strength.

At one of the roof modules, in particular at the sliding roof module, a sealing lip preferably is provided, which rests against the other roof module, in particular at the further roof module. During assembly, the sealing lip thus automatically ensures a sealing between the two roof modules.

According to one embodiment of the invention it is provided that the transverse strut includes two bearing surfaces for the roof modules, wherein the bearing surface associated to the sliding roof module is arranged at a lower level than the bearing surface associated to the further roof module. This configuration takes into account that the sliding roof module usually is constructed higher in vertical direction than the further roof module, in particular when the same is designed as stationary pane. The bearing surfaces arranged at different heights provide for mounting the roof modules directly at the transverse strut, without having to create a separate, module-side height compensation.

According to a preferred embodiment of the invention, the transverse strut is designed as box section which is composed of four individual segments which provide the transverse strut with a high rigidity in z-direction. The strength in particular is so high that the transverse strut can absorb the forces acting in z-direction during bonding of the roof modules, without having to separately support the same. The forces occurring during assembly and in particular during bonding of the roof modules are very much higher than those which occur during operation of the motor vehicle.

Preferably, it is provided that the transverse strut is provided with a lead-through for a cable which leads to a drive of a shading system which is arranged below the further roof element. This lead-through provides for mounting an interior lining of the vehicle directly at the roof construction without having regard to possible cables.

According to an alternative aspect it is provided that the transverse strut is provided with a clipped guide tube through which an actuating element for a shading system extends, which is arranged below the further roof element. Through the guide tube for example a pushing element or a part of a drive cable can extend, with which the shading system is actuated, which is associated to the further roof element.

According to a preferred embodiment of the invention it is provided that the transverse strut each is provided with a gusset plate at its lateral ends. The gusset plate provides for designing the connection between the transverse strut and the vehicle body with a particularly high strength.

Preferably, it is provided that a rear swing-out mechanism of the sliding roof module is mounted at the transverse strut and in particular at the gusset plate. This construction leads to a particularly high rigidity of the rear swing-out mechanism, so that the lid of the sliding roof module is stiffly supported also in the open condition. This provides for using a short support length for the lid in the open condition, whereby a large roof opening can be realized.

Preferably, it is provided that the rear swing-out mechanism includes a swing-out lever which is pivotally mounted at a vehicle-fixed abutment which is connected with the gusset plate. In this construction a direct connection of the rear support of the lid is obtained in the open condition, so that the same can be mounted in a vibration-free manner.

According to one aspect of the invention it is provided that the transverse strut is provided with welding lugs which are welded to the roof construction of the bodyshell. This variant additionally increases the rigidity of the connection of the transverse strut with the bodyshell, in particular when the welding lugs are provided in addition to the gusset plates.

### BRIEF DESCRIPTION OF THE DRAWINGS

The invention will be described below with reference to an embodiment which is represented in the attached drawings, in which:

FIG. 1 shows a perspective exploded view of a roof construction of a motor vehicle;

FIG. 2 shows a perspective view of an end of a transverse strut before its connection with the roof construction;

FIG. 3 shows a perspective view of a transverse strut;

FIG. 4 shows an enlarged top view of an end of a transverse strut;

FIG. 5 shows a top view of a segment of the roof construction;

FIG. 6 shows a section along the plane VI-VI of FIG. 5;

FIG. 7 shows a section along the plane VII-VII of FIG. 5; - FIG. 8 shows a section along the plane VIII-VIII of FIG. 5;

FIG. 9 shows a perspective view of a detail of the transverse strut; and

FIG. 10 shows a schematic perspective view of the end of the transverse strut, to which FIG. 9 relates.

### DETAILED DESCRIPTION

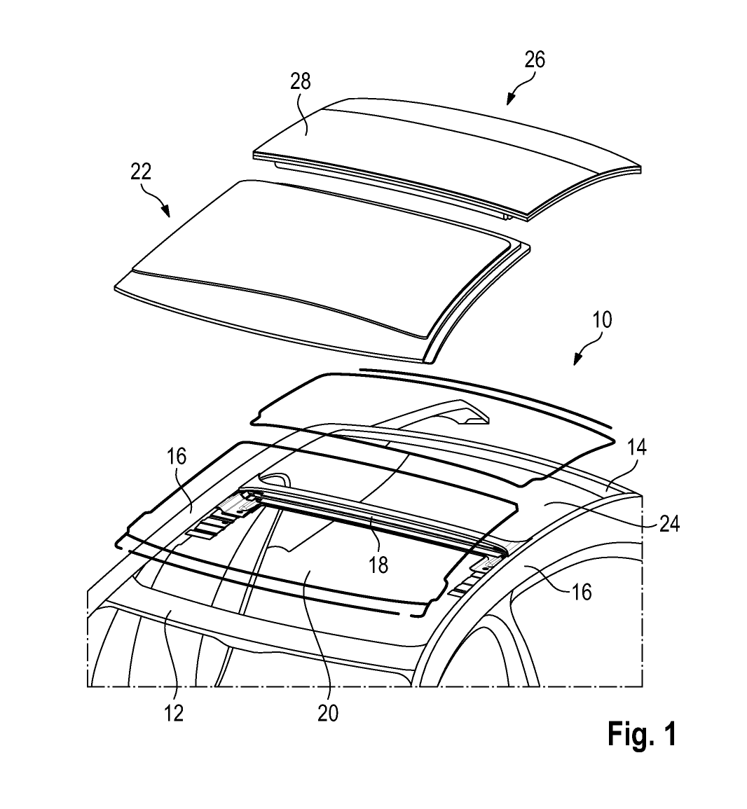

FIG. 1 schematically shows a roof construction 10 which contains a front crossbeam 12, a rear crossbeam 14, two roof rails 16 extending in longitudinal direction, and a transverse strut 18. The beams 12, 14, 16 and the transverse strut 18 belong to a bodyshell of a motor vehicle.

Between the front crossbeam 12 and the transverse strut 18 as well as the corresponding portions of the two longitudinal beams 16 a front roof opening 20 is formed, to which a first roof module 22 is associated. The roof module 22 is designed as sliding roof module.

Between the transverse strut 18 and the rear crossbeam 14 as well as the corresponding portions of the longitudinal beams 16 a rear roof opening 24 is defined, to which a second roof module 26 is associated. This roof module here is designed with a stationary lid 28 which is transparent.

The transverse strut 18 is a composite component which in the middle part is composed of a total of four individual parts (see in particular FIG. 7). The transverse strut 18 consists of an upper chord 30, a lower chord 32 and two center struts 34, 36. The two center struts 34, 36 each include bent flanges with which they are connected with the upper chord 30 and the lower chord 32 over a large surface. In this way a hollow box section is formed, which is very stiff against loads in the z-direction (with reference to FIG. 7 in particular from top to bottom).

Directly adjacent to the center struts 34, 36 shading systems 37 are arranged, which are associated to the sliding roof module 22 and the further roof module 26 and each contain a roller blind.

The upper chord 30 is not designed flat, as shown in FIG. 7, but extends in two planes which are inclined to each other. This results in the formation of two bearing surfaces 38, 40 offset against each other, which are associated to the two roof modules 22, 26. The bearing surface 38 serves for accommodating the sliding roof module 22 which is bonded directly to the bearing surface 38 by means of an adhesive bead 42. More exactly, a frame part 44 of the sliding roof module 22 is bonded directly to the upper chord 30. The bearing surface 38 used for this purpose extends substantially horizontally.

The further, rear roof module 26 is bonded to the second bearing surface 40. The same is slightly tilted, so that it ascends as seen from the front to the rear, and generally extends at a higher level than the first bearing surface 38. For fixing the second roof module, an edge foam cladding 46 of the stationary lid 28 is bonded directly to the second bearing surface 40 (see the adhesive bead 48). Since the second bearing surface 40 is arranged at a higher level than the first bearing surface, the edge foam cladding 46 can be designed thin in vertical direction, so that no interposed reinforcing parts are required and nevertheless the necessary stability is achieved.

Between the sliding roof module 22 and the further roof module 26 a water channel 50 is defined, which is formed directly on the upper chord 30 of the transverse strut 18 between the two adhesive beads 42, 48. Furthermore, the water channel 50 is delineated from a seal 52 which is mounted at the frame 44 of the sliding roof module 22 and is provided with a sealing lip 54. The sealing lip 54 rests against the edge foam cladding 46 of the lid 28 of the second roof module 26, when the same is adhered to its bearing surface 40. The seal is designed such that it is aligned automatically when first the sliding roof module 22 and then the second roof module 26 are mounted.

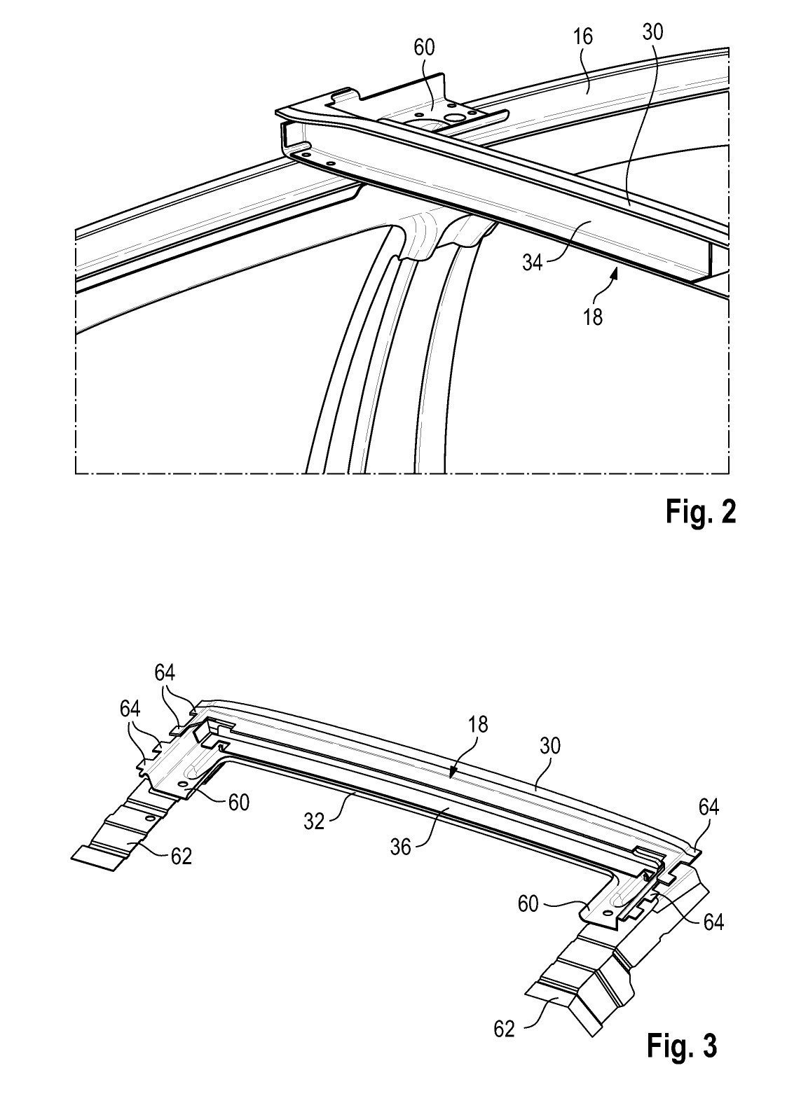

At its ends associated to the longitudinal beams 16 the transverse strut 18 each includes a broadened connecting portion 60 which is formed integrally with the lower chord 32 (see in particular FIGS. 2 to 4). A gusset plate 62 each is connected, in particular riveted, to the connecting portion 60. The gusset plates 62 serve for the large-surface and hence stable attachment of the transverse strut 18 to the longitudinal beams 16 of the bodyshell. To further increase the rigidity of the connection between the transverse strut 18 and the longitudinal beams 16, a plurality of welding lugs 64 are provided at the connecting portion 60 and laterally at the upper chord 30, which are welded to associated portions of the longitudinal beams 16.

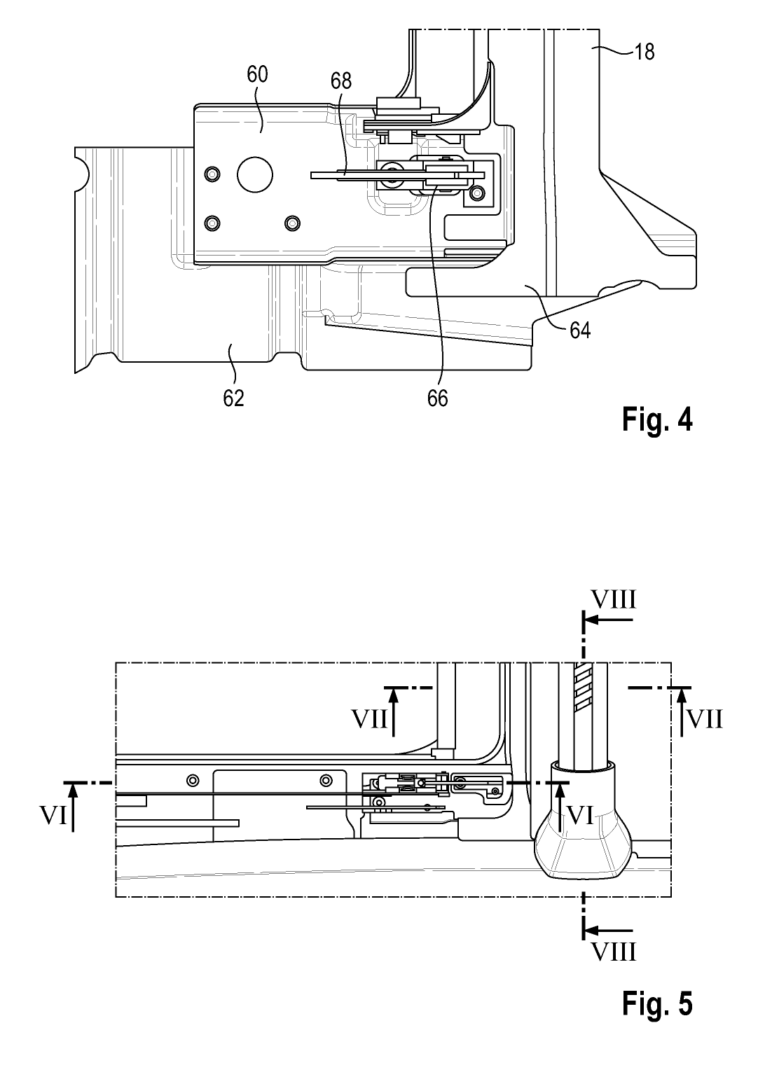

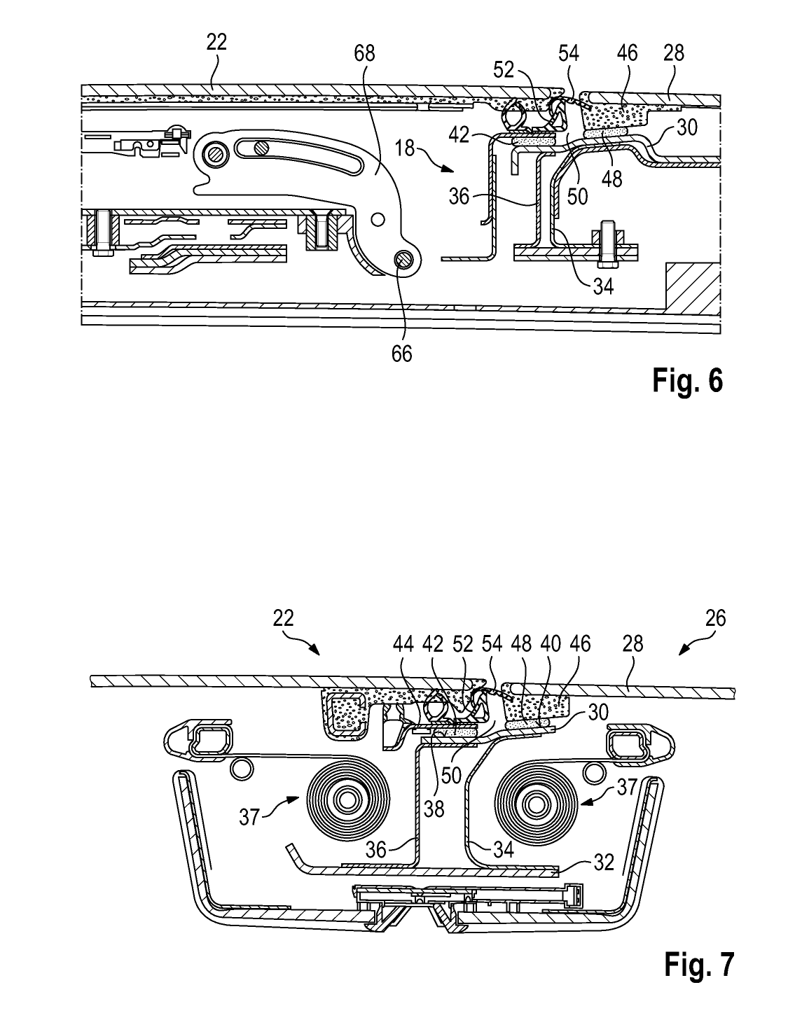

At the connecting portion 60 and also at the associated gusset plate 62 (see in particular FIG. 4) a part of the rear swing-out mechanism of the sliding roof module 22 is mounted, i.e. the mechanism which swings the lid of the sliding roof module 22 to the outside. In concrete terms, an abutment 66 is mounted at the connecting portion 60 and at the gusset plate 62 on each side of the roof construction, in which a swing-out lever 68 is pivotally mounted. The abutment 66 and the swing-out lever 68 are maximally offset to the rear as seen in longitudinal direction, so that they are arranged already in the region of the transverse strut 18. The attachment of the swing-out lever 68 very close to the transverse strut 18 also can be seen very well in FIG. 6.

The attachment of the swing-out lever 68 provides for moving the lid of the sliding roof module 22 very far to the rear, in order to be able to maximally clear the roof opening 20. At the same time, a sufficiently high support length is ensured for the open lid, so that the same is stiffly supported in vertical direction, although it has been maximally moved to the rear. This is also promoted by the particularly stiff attachment of the abutment 66 and the swing-out lever 68 in the region of the gusset plate and the reinforcing portion 60.

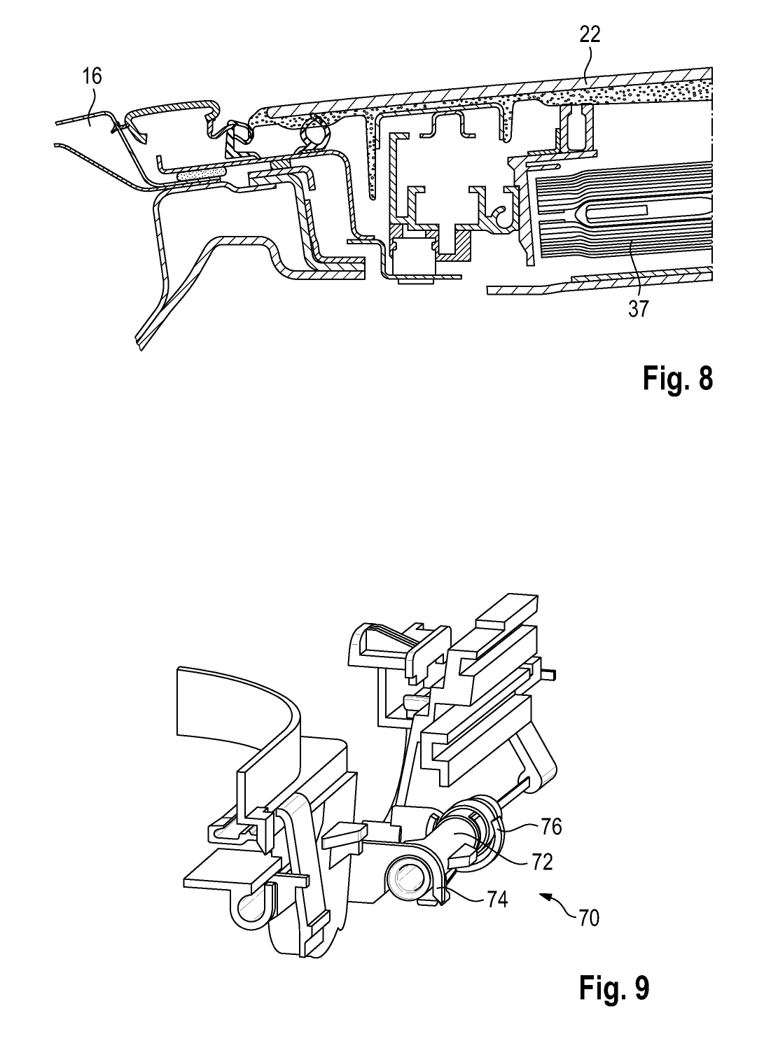

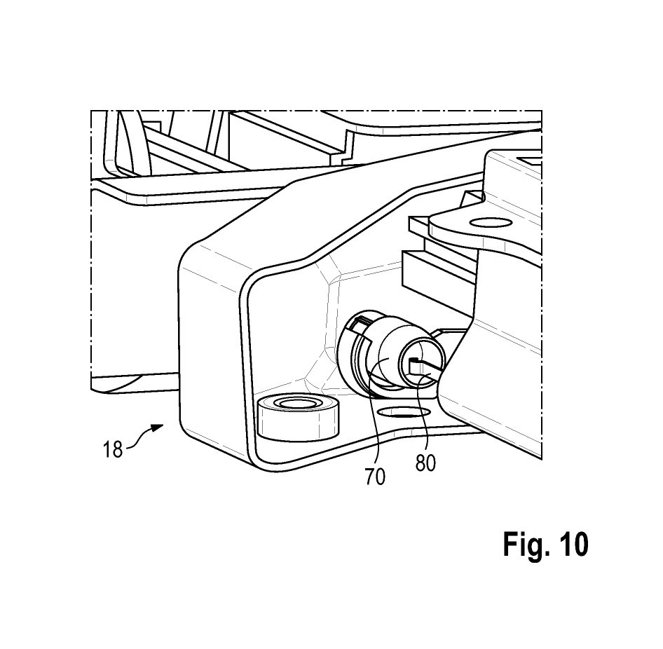

To be able to actuate the shading systems 37 which are associated to the second roof module 26, a lead-through 70 is arranged at the transverse strut 18 (see FIGS. 9 and 10), which here is designed as guide tube. The guide tube 70 is accommodated at the transverse strut 18 in a central portion 72 and for better positioning is enclosed by a front holding clip 74 which is associated to the front shading system 37, and by a rear holding clip 76 which is associated to the rear shading system 37. Through the guide tube 70 an actuating element can be shifted, which meets with an entrainment portion 80 which is coupled with the roller blind of the second shading system 37. The actuating element can be an actuating cable, in particular the end portion of the actuating cable with which the roller blind of the first shading system 37 is actuated. The guide tube 70 thus provides for actuating the second shading system 37 without any detour directly through the transverse strut 18.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

what is claimed is:

1. A roof construction with a sliding roof module and at least one further roof module, wherein between the sliding roof module and the roof module a transverse strut is arranged, which is part of a vehicle body, wherein an edge portion of the sliding roof module and an edge of the roof module are connected with the transverse strut and between the two roof modules a water channel is formed.

2. The roof construction according to claim 1, characterized in that the two roof modules are bonded to the transverse strut.

3. The roof construction according to claim 2, characterized in that the further roof module is foam-clad with polyurethane (PU) at its edge associated to the transverse strut, wherein the polyurethane (PU) does not have a reinforcing element in the region of this edge.

4. The roof construction according to claim 3, characterized in that the further roof module is bonded directly to the transverse strut by means of its foam cladding.

5. The roof construction according to claim 4, characterized in that at one of the roof modules a sealing lip is provided, which rests against the other roof module.

6. The roof construction according to claim 5, characterized in that at the sliding roof module a sealing lip is provided, which rests against the further roof module.

7. The roof construction according to claim 6, characterized in that the transverse strut includes two bearing surfaces for the roof modules, wherein the bearing surface associated to the sliding roof module is arranged at a lower level than the bearing surface associated to the further roof module.

8. The roof construction according to claim 7, characterized in that the transverse strut is designed as box section which is composed of four individual segments which provide the transverse strut with a high rigidity in z-direction.

9. The roof construction according to claim 8, characterized in that the transverse strut is provided with a lead-through for a cable which leads to a drive of a shading system which is arranged below the further roof element.

10. The roof construction according to claim 9, characterized in that the transverse strut is provided with a clipped guide tube through which an actuating element for a shading system extends, which is arranged below the further roof element.

11. The roof construction according to claim 10, characterized in that a rear swing-out mechanism of the sliding roof module is mounted at the transverse strut.

12. The roof construction according to claim 11, characterized in that the transverse strut each is provided with a gusset plate at its lateral ends.

13. The roof construction according to claim 12, characterized in that a rear swing-out mechanism of the sliding roof module is mounted at the gusset plate.

14. The roof construction according to claim 13, characterized in that the rear swing-out mechanism includes a swing-out lever which is pivotally mounted at a vehicle-fixed abutment which is connected with the gusset plate.

15. The roof construction according to claim 14, characterized in that the transverse strut is provided with welding lugs which are welded to the roof construction of the bodyshell.

16. The roof construction according to claim 1, characterized in that the transverse strut includes two bearing surfaces for the roof modules, wherein the bearing surface associated to the sliding roof module is arranged at a lower level than the bearing surface associated to the further roof module.

17. The roof construction according to claim 1, characterized in that the transverse strut is provided with a lead-through for a cable which leads to a drive of a shading system which is arranged below the further roof element.

18. The roof construction according to claim 1, characterized in that a rear swing-out mechanism of the sliding roof module is mounted at the transverse strut.

19. The roof construction according to claim 1, characterized in that a rear swing-out mechanism of the sliding roof module is mounted at the gusset plate.

20. The roof construction according to claim 1, characterized in that the further roof module is foam-clad with polyurethane (PU) at its edge associated to the transverse strut, wherein the polyurethane (PU) does not have a reinforcing element in the region of this edge further characterized in that the further roof module is bonded directly to the transverse strut by means of its foam cladding.
